(19) United States
(12) Patent Application Publication
(10) Pub. No.: US 2014/0352413 A1
(43) Pub. Date: Dec. 4, 2014

(54) MOISTURE TRANSMISSION TESTING INSTRUMENT

(71) Applicant: SAMSUNG ELECTRO-MECHANICS CO., LTD., Suwon-si (KR)

(72) Inventors: Hee Jin PARK, Suwon-si (KR); Seung Mi LEE, Suwon-si (KR); Suk Jin HAM, Suwon-si (KR)

(73) Assignee: SAMSUNG ELECTRO-MECHANICS CO., LTD., Suwon-si (KR)

(21) Appl. No.: 14/289,341

(22) Filed: May 28, 2014

(30) Foreign Application Priority Data
Jun. 4, 2013 (KR) 10-2013-0064102

(51) Int. Cl. G01N 7/14

(52) U.S. Cl. CPC G01N 7/14
USPC 73/73

(57) ABSTRACT

Disclosed herein is a moisture transmission testing instrument of measuring moisture transmission of an electronic material, the moisture transmission testing instrument including: a moisture supplying part having an opened upper portion and having water stored therein; a sample support part stacked on the moisture supplying part so as to be communicated with the moisture supplying part and having a sample seated on an upper side thereof; and a moisture collecting part stacked on the sample support part so as to be communicated with the sample support part and having a dehumidifying agent installed therein.

### CROSS REFERENCE(S) TO RELATED APPLICATIONS

This application claims the benefit under 35 U.S.C. Section 119 of Korean Patent Application Serial No. 10-2013-0064102, entitled “Moisture Transmission Testing Instrument” filed on Jun. 4, 2013, which is hereby incorporated by reference in its entirety into this application.

### BACKGROUND OF THE INVENTION

1. Technical Field

The present invention relates to a moisture transmission testing instrument, and more particularly, to a moisture transmission testing instrument of measuring moisture transmission of an electronic material.

2. Description of the Related Art

In general, moisture has a major impact on reliability of an electronic material and changes electrical characteristics of a component through a change in mechanical property.

Particularly, a touch screen module often causes electrical connection defect under a high-temperature and high-humidity environment, because the moisture degrades conductivity property of a material in a conductive polymer material.

As such, the moisture has a major influence on characterization of an electronic material and becomes an important factor in determining reliability of a product.

Currently, examples of a method for measuring moisture transmission of the electronic material include a gravimetric method in which a weight of moisture transmitting a sample is measured by a scale in external atmosphere having humidity and a desiccant placed therein, and a quantitative method of measuring transmitted moisture content by applying moisture to one side of a transmission sample placed at a middle to thereby detect the moisture transmitted toward an opposite side of the sample using a sensor at given temperature and humidity.

However, recently, since the quantitative method measuring the moisture content using the sensor mainly uses a coulometric sensor, there is a limitation in detecting the moisture content.

That is, since the coulometric sensor may detect the transmitted moisture of only about a few mg to 50 g per unit time for unit area, it has a limitation in accurately detecting an amount of transmitted moisture for the electronic material having the amount of transmitted moisture of several tens gram or more.

[Related Art Document]

[Patent Document]

(Patent Document 1) Cited Reference: Korean Patent Laid-Open Publication No. 2011-0019458

### SUMMARY OF THE INVENTION

An object of the present invention is to provide a moisture transmission testing instrument capable of precisely measuring a transmitted amount of moisture by collecting an entire quantity of moisture transmitting a sample in a closed space.

Another object of the present invention is to provide a moisture transmission testing instrument capable of precisely measuring a transmitted amount of moisture transmitting the sample by injecting nitrogen gas classified as dry gas into a space having a dehumidifying agent placed therein and discharging only the nitrogen gas.

According to an exemplary embodiment of the present invention, there is provided a moisture transmission testing instrument, including: a moisture supplying part having an opened upper portion and having water stored therein; a sample support part stacked on the moisture supplying part so as to be communicated with the moisture supplying part and having a sample seated on an upper side thereof; and a moisture collecting part stacked on the sample support part so as to be communicated with the sample support part and having a dehumidifying agent installed therein.

The moisture supplying part may include an enclosure having the water received therein and a water injection hole connected to a side of the enclosure, and the sample supporting part may be configured of a support having a plurality of holes formed therein and a heating tape formed along a circumferential surface of the support.

The sample supporting part may further have a gasket provided at upper and lower portions thereof so that an airtight seal of the support is maintained, and a sealing material such as an O-ring other than the gasket may be used.

The moisture collecting part may include a case having a plurality of gas inlets formed therein and a transparent window coupled to a front of the case so as to be opened or closed.

The moisture collecting part may have a gas supplying pipe and a gas discharging pipe connected thereto so as to supply and discharge nitrogen gas to and from an inner portion of the case.

The moisture collecting part may further have a suspended net at which the dehumidifying agent is held.

The dehumidifying agent may be configured of a vessel body having dehumidifying materials received therein, and moisture inlet hole and outlet hole formed at both side ends of the vessel body.

The dehumidifying agent may have a gas outlet hole connected to the gas discharging pipe, such that only the nitrogen gas is discharged.

According to another exemplary embodiment of the present invention, there is provided a moisture transmission testing instrument, including: a moisture supplying part having an opened upper portion and having water stored therein; and a moisture collecting part having a sample seated so as to cover an upper portion of the moisture supplying part and having a dehumidifying agent installed on the sample.

### BRIEF DESCRIPTION OF THE DRAWINGS

FIG. 1 is a perspective view showing a moisture transmission testing instrument according to an exemplary embodiment of the present invention;

FIG. 2 is a cross-sectional view of the moisture transmission testing instrument according to the exemplary embodiment of the present invention;

FIG. 3 is a perspective view showing a moisture supplying part of the moisture transmission testing instrument according to the exemplary embodiment of the present invention;

FIG. 4 is a perspective view showing a sample supporting part of the moisture transmission testing instrument according to the exemplary embodiment of the present invention; and

FIG. 5 is a perspective view showing a moisture collecting part of the moisture transmission testing instrument according to the exemplary embodiment of the present invention.

### DESCRIPTION OF THE PREFERRED EMBODIMENTS

Hereinafter, an exemplary embodiment of the present invention will be described in detail with reference to the accompanying drawings.

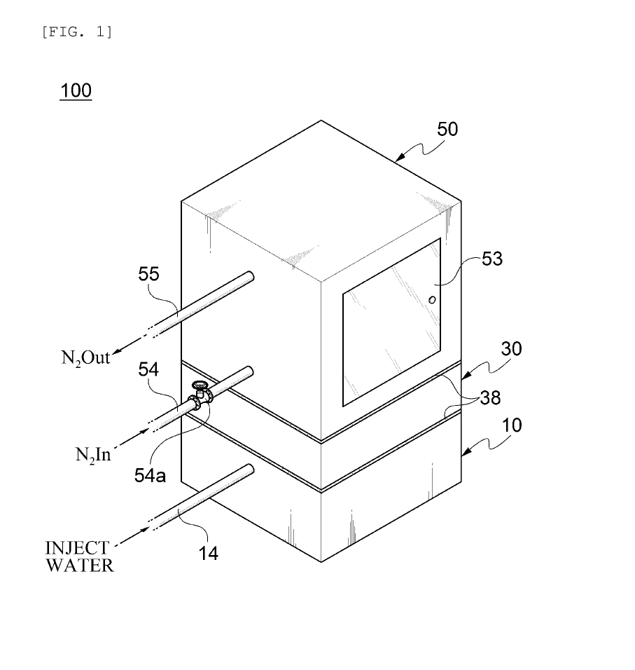

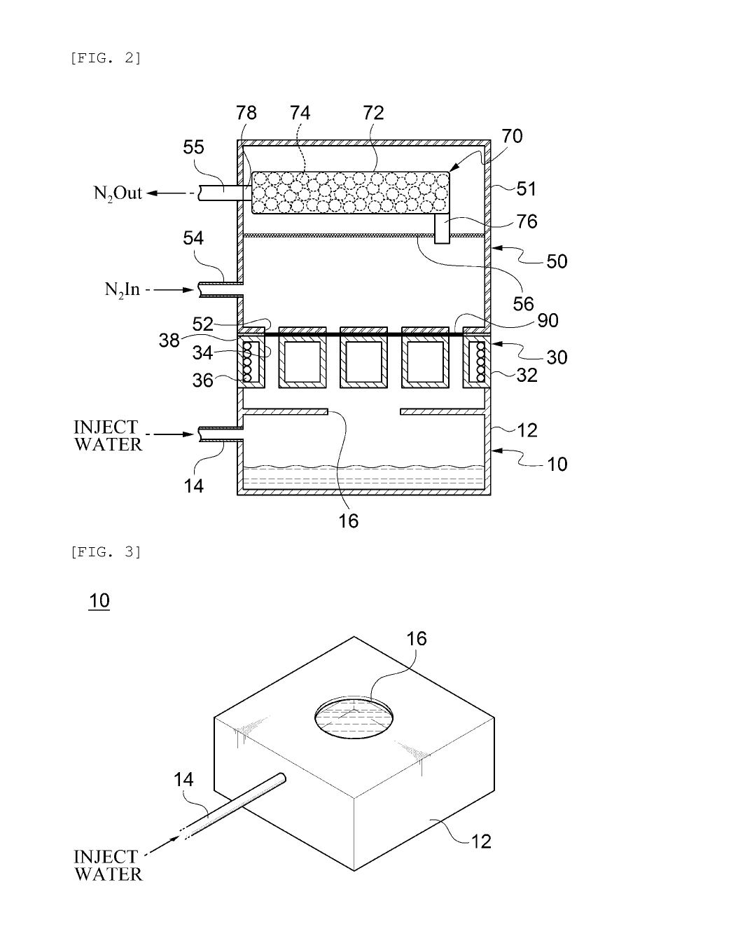

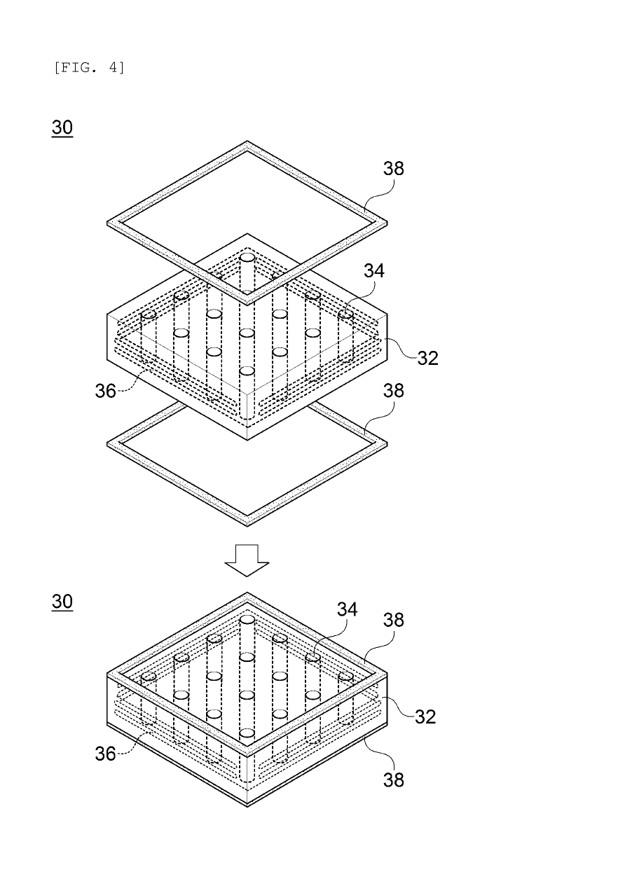

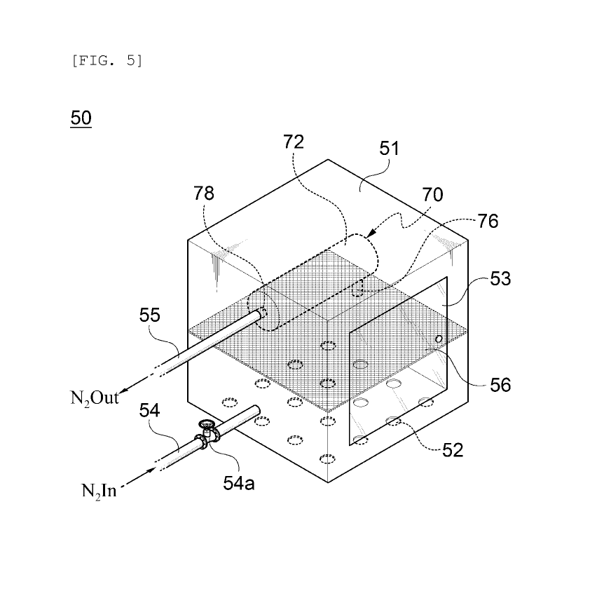

FIG. 1 is a perspective view showing a moisture transmission testing instrument according to an exemplary embodiment of the present invention, FIG. 2 is a cross-sectional view of the moisture transmission testing instrument according to the exemplary embodiment of the present invention, FIG. 3 is a perspective view showing a moisture supplying part of the moisture transmission testing instrument according to the exemplary embodiment of the present invention, FIG. 4 is a perspective view showing a sample supporting part of the moisture transmission testing instrument according to the exemplary embodiment of the present invention, and FIG. 5 is a perspective view showing a moisture collecting part of the moisture transmission testing instrument according to the exemplary embodiment of the present invention.

As shown in the drawings, a moisture transmission testing instrument 100 according to an exemplary embodiment of the present invention include a moisture supplying part 10 in which water is stored, a sample supporting part 30 stacked on the moisture supplying part, and a moisture collecting part 50 stacked on the sample supporting part and having a dehumidifying agent 70 installed therein.

The moisture supplying part 10 includes an enclosure 12 receiving the water and a water injection hole 14 connected to a side of the enclosure 12.

The enclosure 12 may have an upper surface which is entirely opened, but may be configured in a state in which a hole 16 having a predetermined size is formed at only the center portion of the upper surface.

The water is received in the enclosure 12 of the moisture supplying part and is supplied to the enclosure 12 through the water injection hole 14 formed at the side of the enclosure 12.

In addition, although not shown in the drawings, a sponge supporting part may be formed below the opened hole 16 of the enclosure so that a moistened sponge may be disposed.

The sample supporting part 30 is stacked on the above-mentioned moisture supplying part 10 so as to be communicated with the moisture supplying part 10.

The sample supporting part 30 may be configured of a support 32 having a plurality of holes formed therein and a heating tape 36 formed along a circumferential surface of the support 32.

The hole 34 formed in the support 32 serves as a passage so that the moisture stored in the enclosure 12 of the moisture supplying part may be moved upwardly, and the plurality of holes 34 may be punched while maintaining an equal interval therebetween.

In addition, the heating tape 36 is attached to the circumferential surface of the support 32 so as to increase a temperature of the support 32 to thereby increase an evaporating rate of the moisture. When the heating tape 36 is attached to the support 32, the heating tape 36 may be attached to the entire circumferential surface or may be restrictively attached to a partial surface of the circumferential surface.

In addition, a gasket 38, an O-ring, or the like may be formed on an upper side of the support 32 and an upper surface of the enclosure 12 so that an airtight seal with the moisture collecting part 50 stacked on the support 32 may be maintained.

In this case, although not shown in the drawings, the sample may be seated on the support 32 using a sealing material such as grease so as to maintain the airtight seal, and in a case of a liquefied sample, the liquefied sample may be directly applied to the support and then be cured.

The moisture collecting part 50 is stacked on the support 32 so as to be communicated with the support 32 and has the dehumidifying agent 70 installed therein.

The moisture collecting part 50 includes a case 51 having a plurality of moisture holes 52 formed therein and a transparent window 53 coupled to a front of the case 51 so as to be opened or closed.

The moisture hole 52 formed in the case 51 is punched in the same diameter and axial line as the hole 34 so that the moisture supplied through the hole 34 of the sample support may be introduced into the case 51.

In addition, the case 51 may have a gas supplying pipe 54 and a gas discharging pipe 55 connected to a side thereof so that the nitrogen gas may be supplied to and discharged from the case 51.

The nitrogen gas, which is typical dry gas, is introduced and discharged in order to precisely measure only a weight of the moisture at the time of collecting the moisture.

The gas supplying pipe 54 and the gas discharging pipe 55 may be installed with a valve 54a adjusting gas flow, a pressure gauge (not shown), and the like.

In addition, the case 51 may have the dehumidifying agent 70 disposed therein so that the moisture content introduced into the case 51 may be measured.

The dehumidifying agent 70 may be configured of a vessel body 72 having a dehumidifying material 74 received therein, and a moisture inlet hole 76 and a moisture outlet hole 78 formed at both side ends of the vessel body 72.

As the dehumidifying material 74, the material having a dehumidification function such as silica gel may be used and another material having the dehumidification function other than the silica gel may be selectively used.

In this case, the humidifying agent 70 may be held at a suspended net 56 installed in the case 51 so as to maintain a stable installation state in the case 51.

In addition, in a state in which the dehumidifying agent 70 is held at the suspended net 56, the moisture inlet hole 76 is exposed in the case 51 as it is and on the other hand, the moisture outlet hole 78 is connected to the gas discharging pipe 55.

As such, the reason that the moisture outlet hole 78 and the gas discharging pipe 55 are connected to each other is to collect the moisture content in the case 51 using the dehumidifying material 74 and visually confirm the dehumidified moisture content.

That is, when the nitrogen gas is introduced into the case 51 through the gas supplying pipe 54, a state in which the moisture moved into the case 51 is filled in the case 51 together with the nitrogen gas is made. In this state, when air is sucked from the gas discharging pipe 55, the nitrogen gas transmits the dehumidifying material 74 as it is and the moisture is collected in the dehumidifying material 74.

After the moisture is collected in the dehumidifying material 74, the humidifying agent 70 is taken out from the case 51 and the weight thereof is measured.

The moisture transmission testing instrument 100 according to the exemplary embodiment of the present invention configured as described above supplies the water to the water injection hole 14 so as to fill a certain amount of water in the enclosure 12, when the sample 90 is seated on the sample supporting part 30.

Once the water is filled in the enclosure 12, the evaporated moisture starts to transmit the sample 90. In this case, the heating tape 36 of the sample support further increases the evaporating rate of moisture to thereby increase a rate of transmitting the sample 90.

The moisture transmitting the sample 90 as described above is entered into the case 51 by passing the moisture hole 52 of the case and the nitrogen gas is supplied from the gas supplying pipe 54 connected to an inner portion of the case 51.

Therefore, the inner portion of the case 51 becomes a state in which the moisture and the nitrogen gas are mixed. In this case, once the gas discharging pipe 55 is operated, the nitrogen gas and the moisture are introduced into the moisture inlet hole 76 of the dehumidifying agent and are discharged to the gas discharging pipe 55 through the dehumidifying material 74.

In this case, the nitrogen gas passes through the dehumidifying material 74, as it is and the moisture is collected in the dehumidifying material 74.

When the above-mentioned processes are performed and all of the time for measuring the moisture transmitting amount of the sample 90 is lapsed, the dehumidifying agent 70 is taken out from the case 51 and the weight of the collected moisture is measured.

Meanwhile, the moisture transmission testing instrument 100 according to the exemplary embodiment of the present invention may be configured to include the moisture supplying part 10 and the moisture collecting part 50 stacked on the moisture supplying part 10.

More specifically, the sample 90 is seated so as to cover an upper side of the enclosure 12 of the moisture supplying part.

In this case, when the nitrogen gas is introduced into the moisture collecting part 50 through the gas supplying pipe 54 and is then discharged to the gas discharging pipe 55, the moisture received in the enclosure 12 of the moisture supplying part transmits the sample 90 while being moved upwardly.

The moisture transmitting the sample 90 as described above is introduced through the moisture inlet hole 76 of the dehumidifying agent together with the nitrogen gas so as to be collected in the dehumidifying material 74, and only the nitrogen gas which is not collected is moved to the gas discharging pipe 55 through the moisture outlet hole 78.

After the moisture is collected by the dehumidifying material 74 during a predetermined time, the transparent window 53 of the case is opened, the moisture outlet hole 78 and the gas discharging pipe 55 are separated, and the dehumidifying agent 70 is then taken out from the inner portion of the case 51.

The weight of the moisture of the dehumidifying agent 70 taken out from the case 51 is precisely measured by a weight measuring apparatus (not shown).

As such, the moisture transmission testing instrument 100 according to the exemplary embodiment of the present invention may precisely measure the moisture transmitting amount of the sample 90 because all of the transmitted moisture may be collected by the dehumidifying agent 70 even when a lot of moisture transmits the sample 90.

According to the exemplary embodiment of the present invention, the moisture transmission testing instrument may precisely measure the transmitted amount of moisture by collecting the entire quantity of moisture transmitting the sample in the closed space.

According to another exemplary embodiment of the present invention, the transmitted amount of moisture transmitting an electronic material may be precisely measured by injecting the nitrogen gas classified as the dry gas into the space having the dehumidifying agent placed therein and discharging only the nitrogen gas to thereby measure the weight of the dehumidifying agent.

Although the moisture transmission testing instrument according to the exemplary embodiment of the present invention has been described, the present invention is not limited thereto, but those skilled in the art will appreciate that various applications and modifications are possible.

1. A moisture transmission testing instrument, comprising:
a moisture supplying part having an opened upper portion and having water stored therein;
a sample support part stacked on the moisture supplying part so as to be communicated with the moisture supplying part and having a sample seated on an upper side thereof; and
a moisture collecting part stacked on the sample support part so as to be communicated with the sample support part and having a dehumidifying agent installed therein.

2. The moisture transmission testing instrument according to claim 1, wherein the moisture supplying part includes an enclosure having the water received therein and a water injection hole connected to a side of the enclosure.

3. The moisture transmission testing instrument according to claim 1, wherein the sample supporting part is configured of a support having a plurality of holes formed therein and a heating tape formed along a circumferential surface of the support.

4. The moisture transmission testing instrument according to claim 3, wherein the sample supporting part further has a gasket provided at upper and lower portions thereof so that an airtight seal of the support is maintained.

5. The moisture transmission testing instrument according to claim 1, wherein the moisture collecting part includes a case having a plurality of gas inlets formed therein and a transparent window coupled to a front of the case so as to be opened or closed.

6. The moisture transmission testing instrument according to claim 5, wherein the moisture collecting part has a gas supplying pipe and a gas discharging pipe connected thereto so as to supply and discharge nitrogen gas to and from an inner portion of the case.

7. The moisture transmission testing instrument according to claim 1, wherein the moisture collecting part further has a suspended net at which the dehumidifying agent is held.

8. The moisture transmission testing instrument according to claim 1, wherein the dehumidifying agent is configured of a vessel body having dehumidifying materials received therein, and moisture inlet hole and outlet hole formed at both side ends of the vessel body.

9. The moisture transmission testing instrument according to claim 6, wherein the dehumidifying agent has a gas outlet hole connected to the gas discharging pipe, such that only the nitrogen gas is discharged.

10. A moisture transmission testing instrument, comprising:
a moisture supplying part having an opened upper portion and having water stored therein; and
a moisture collecting part having a sample seated so as to cover an upper portion of the moisture supplying part and having a dehumidifying agent installed on the sample.

11. The moisture transmission testing instrument according to claim 10, wherein the moisture supplying part includes an enclosure having the water received therein and a water injection hole connected to a side of the enclosure.

12. The moisture transmission testing instrument according to claim 10, wherein the moisture collecting part includes a case having a plurality of gas inlets formed therein and a transparent window coupled to a front of the case so as to be opened or closed.

13. The moisture transmission testing instrument according to claim 12, wherein the moisture collecting part has a gas supplying pipe and a gas discharging pipe connected thereto so as to supply and discharge nitrogen gas to and from an inner portion of the case.

14. The moisture transmission testing instrument according to claim 10, wherein the moisture collecting part further has a suspended net at which the dehumidifying agent is held.

15. The moisture transmission testing instrument according to claim 10, wherein the dehumidifying agent is configured of a vessel body having dehumidifying materials received therein, and moisture inlet hole and outlet hole formed at both side ends of the vessel body.

16. The moisture transmission testing instrument according to claim 13, wherein the dehumidifying agent has a gas outlet hole connected to the gas discharging pipe, such that only the nitrogen gas is discharged.

17. The moisture transmission testing instrument according to claim 8, wherein the dehumidifying agent has a gas outlet hole connected to the gas discharging pipe, such that only the nitrogen gas is discharged.

18. The moisture transmission testing instrument according to claim 15, wherein the dehumidifying agent has a gas outlet hole connected to the gas discharging pipe, such that only the nitrogen gas is discharged.
